(19) United States
(12) Patent Application Publication
(10) Pub. No.: US 2004/0223688 A1
(43) Pub. Date: Nov. 11, 2004

(54) Device for finding first light using multimode fiber for multichannel optoelectronic component alignment

(76) Inventor: Jay Y. Jeong, Lake Forest, CA (US)

Correspondence Address: IRELL & MANELLA LLP, 840 NEWPORT CENTER DRIVE, SUITE 400, NEWPORT BEACH, CA, 92660, US

(21) Appl. No.: 10/411,670

(22) Filed: Apr. 10, 2003

(51) Int. Cl. G02B 6/26; G02B 6/42

(52) U.S. Cl. 385/25; 385/52

(57) ABSTRACT

An alignment station for aligning an input fiber array to a waveguide. The station can also align an output fiber array to the waveguide. The alignment station includes a first stage that supports the input fiber array and a second stage that support the waveguide. The alignment station further includes a third stage that supports a multimode fiber. The first, second and/or third stages can be either manually or automatically moved in at least one degree of freedom. The multimode fiber is connected to an optical sensor such as an IR camera or photodetector. The multimode fiber has a relatively large aperture so that the fiber picks up light when initially placed adjacent to the waveguide. An output fiber array can be mechanically coupled to the multimode fiber so that the output array can be readily aligned with the waveguide after alignment between the input array and the waveguide.

### BACKGROUND OF THE INVENTION

1. Field of the Invention

The present invention relates to an alignment station to align fiber arrays with a waveguide.

2. Background Information

There are passive optical components that contain an optical waveguide coupled to both an input fiber array and an output fiber array. The input fiber array may be coupled to a laser diode array that provides multiple beams of light. The waveguide may be an optical switch or mixer that optically processes the beams of light.

The waveguide components are typically assembled by initially aligning the input fiber array with the waveguide. A light beam is directed through both the input array and the waveguide and then detected with an optical sensor. The optical sensor may be an infrared (IR) camera or a power meter.

When an IR camera is used, an operator views a monitor and moves either the input array and/or waveguide until he/she sees light emitting from the waveguide. The operator can provide fine movement of the input array and/or waveguide until the brightest beam is emitted by the waveguide, indicating alignment between the components. The process can also be automated so that a computer automatically moves the input array and/or waveguide until a beam of maximum intensity is detected by the camera. One disadvantage of using an IR camera detector is that the camera also detects ambient light. The ambient light decreases the signal to noise ratio of the system and increases the time required to align the input array with the waveguide.

A power meter based alignment system includes a single mode fiber optic cable connected to a power meter. The fiber is aligned with the waveguide to detect emitted light. Such systems are typically automated so that the input array and/or waveguide are moved until the photodetector detects a maximum intensity of light emitted by the waveguide. The photodetector may not detect light when the fiber is initially placed adjacent to the waveguide. Without any light detection the operator or automated system does not know which direction to move the input array or the waveguide. Even if light is detected, often it is noise and the alignment algorithm fails to achieve an optimal alignment. It would be desirable to provide an alignment station that improved the process of initially locating light emitted from a waveguide.

### BRIEF SUMMARY OF THE INVENTION

An alignment station with a first stage that supports an input fiber array, a second stage that supports a waveguide, and a third stage that supports a multimode fiber. The multimode fiber is coupled to an optical sensor. The third stage and multimode fiber can move relative to the waveguide.

### BRIEF DESCRIPTION OF THE DRAWINGS

FIG. 1 is a schematic of an alignment station;

FIG. 2 is an alternate embodiment of the alignment station.

### DETAILED DESCRIPTION

Disclosed is an alignment station for aligning an input fiber array to a waveguide. The station can also align an output fiber array to the waveguide. The station includes a first stage that supports the input fiber array and a second stage that support the waveguide. The alignment station further includes a third stage that supports a multimode fiber. The first, second and/or third stages can be either manually or automatically moved in at least one degree of freedom. The multimode fiber is connected to an optical sensor such as an IR camera or photodetector. The multimode fiber has a relatively large aperture so that the fiber picks up light when initially placed adjacent to the waveguide. An output fiber array can be mechanically coupled to the multimode fiber so that the output array can be readily aligned with the waveguide after alignment between the input array and the waveguide.

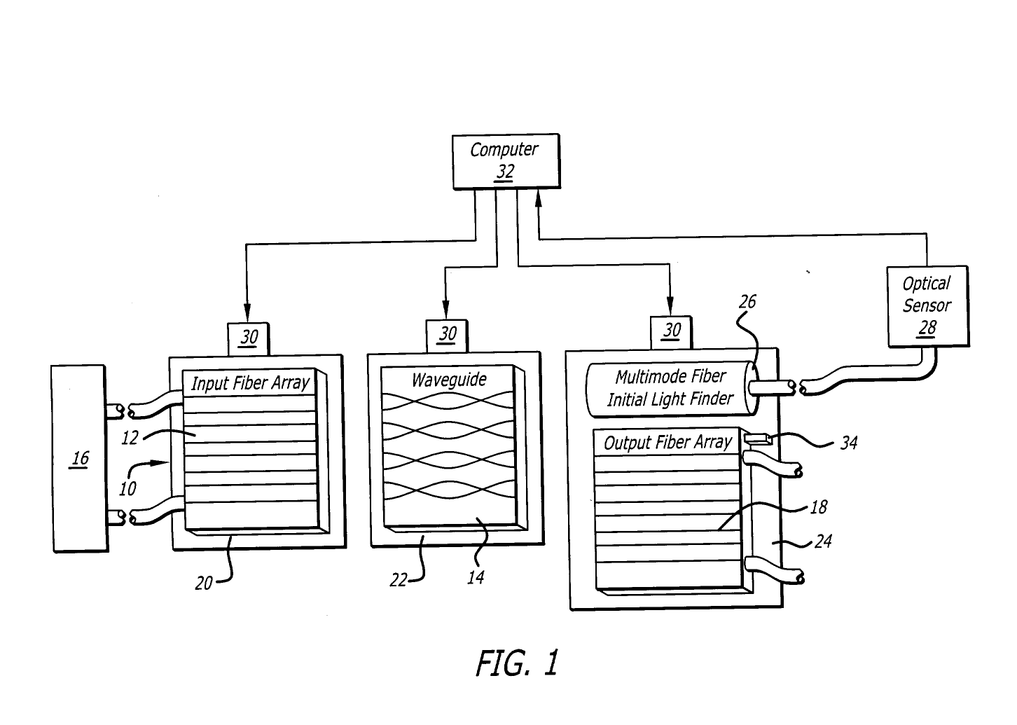

Referring to the drawings more particularly by reference numbers, FIG. 1 shows an alignment station 10. The alignment station 10 can be used to align an input fiber array 12 to a waveguide 14. The input fiber array 12 is typically coupled to an external light source 16. By way of example, the light source 16 may be a laser diode array that emits multiple beams of light. The waveguide 14 may be an optical switch or an optical mixer. The fiber array 12 couples the light beams into the waveguide 14. The alignment station 10 may be used to further align an output fiber array 18 to the waveguide 14.

The station 10 may include a first stage 20 that supports the input array 12 and a second stage 22 that supports the waveguide 14. The station 10 may further include a third stage 24 that supports the output fiber array 18 and a multimode fiber 26. The multimode fiber 26 is connected to an optical sensor 28. By way of example, the optical sensor 28 may be an IR camera or a photodetector. The photodetector may be a single cell, bi-cell or quad-cell device. The IR camera may be connected to a video monitor (not shown) that can be viewed by an operator.

Each stage 20, 22 and 24 may have up to six degrees of freedom to allow the waveguide 14, and arrays 12 and 18 to move relative to each other. The stages 20, 22 and 24 can be moved to align the waveguide 14 with the input array 12 and the output array 18 with the waveguide 14. Each stage 20, 22 and 24 may have mechanical platforms (not shown) and translational screws (not shown) to allow an operator to manually move the waveguide 14, and arrays 12 and 18.

The station 10 may also be configured to include motors 30 that move the stages 20, 22 and 24 up to six degrees of freedom. The motors 30 may be coupled to a computer 32. The computer 32 may receive feedback from the optical sensor 28 regarding the detection of light emitted by the waveguide 14. The computer 32 may operate in accordance with a firmware and/or software program that activates the motors 30 to automatically align the arrays 12 and 18, to the waveguide 14 based on the detection of light by the sensor 28.

The stages 20, 22 and 24 can be constructed to have a combination of motors 30 and manually actuated devices (translation screws) to move the parts 12, 14 and 18. Although the first 20 and second 22 stages are described as having up to six degrees of freedom, it is to be understood that either the first stage 20 or the second stage 22 may be stationary.

In operation, the input array 12 can be placed onto the first stage 20, the waveguide 14 can be placed onto the second stage 22, and both the multimode fiber 26 and output array 18 can be placed onto the third stage 24. The input array 12 is coupled to the light source 16. The light source 16 is energized to emit light that travels through the input array 12 and the waveguide 14. The light enters the multimode fiber 26 and is detected by the light sensor 28. Because the multimode fiber 26 has a relatively large aperture the fiber 26 will pick up the light beam even if there is not an exact alignment with the waveguide 14.

For a manual system the operator can manually move the first stage 20 and/or second stage 22 until the brightest beam is seen on a monitor (not shown). For an automated system, the computer 32 may drive the motors 30 of the stages 20 and/or 22 until a maximum intensity is detected by the sensor 28.

After the waveguide 14 is aligned with the input array 12, the third stage 24 may be moved a predetermined distance to align the output array 18 with the waveguide 14. The third stage 24 may include a mechanical stop 34 that establishes a known distance between the multimode fiber 26 and the output array 18. The mechanical stop 34 may be any device or feature such as a plate or pin that establishes a repeatable known distance between the multimode fiber 26 and the output array 18. After the multimode fiber 26 is aligned with the waveguide 14 the third stage 24 can move the known distance to automatically align the output fiber array 18.

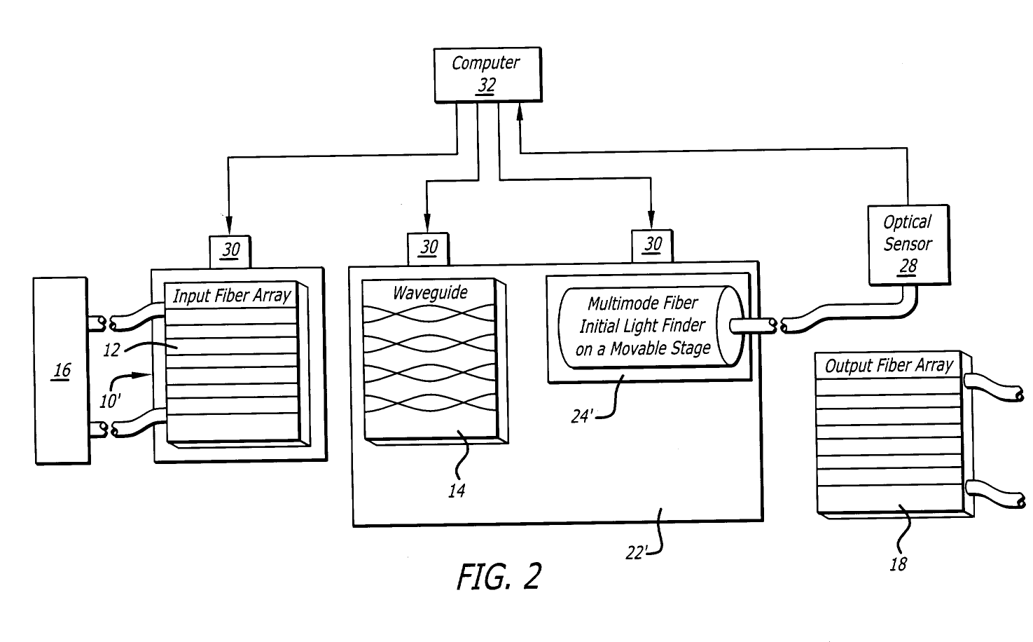

FIG. 2 shows an alternate embodiment of an alignment station 10′ that is used to align the waveguide 14 with the input array 12. The third stage 24′ may be coupled to the second stage 22 to allow light detection through the multimode fiber 26. With this embodiment the output array 18 is not loaded onto the third stage 24′.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, although a multimode fiber is described, it is to be understood that other multimode waveguides such as a multimode planar waveguide can be used instead of the fiber.

What is claimed is:

1. An alignment station used to align an input fiber array with a waveguide, comprising:
a first stage that supports the input fiber array;
a second stage that supports the waveguide;
a third stage that can move in at least one degree of freedom;
a multimode fiber coupled to said third stage; and
an optical sensor coupled to said multimode fiber.

2. The station of claim 1, wherein said third stage supports an output fiber array.

3. The station of claim 2, wherein said third stage includes a mechanical stop to establish a known distance between said multimode fiber and the output fiber array.

4. The station of claim 1, wherein said optical sensor is a photodetector.

5. The station of claim 1, wherein said optical sensor is an infrared camera.

6. The station of claims 1, wherein said first stage can move in at least one degree of freedom.

7. The station of claim 1, wherein said second stage can move in at least a one degree of freedom.

8. The station of claim 1, further comprising a motor coupled to said third stage and a computer coupled to said motor and said optical sensor.

9. An alignment station to align an input fiber array with a waveguide, comprising:
a first stage that supports the input fiber array;
a second stage that supports the waveguide;
a third stage that can move in at least one direction;
an optical sensor; and,
coupling means for optically coupling said optical sensor to the waveguide.

10. The station of claim 9, wherein said third stage supports an output fiber array.

11. The station of claim 10, further comprising reference means for establishing a known distance between said coupling means and the output fiber array.

12. The station of claim 9, wherein said optical sensor is a photodetector.

13. The station of claim 9, wherein said optical sensor is an infrared camera.

14. The station of claims 9, wherein said first stage can move in at least one degree of freedom.

15. The station of claim 9, wherein said second stage can move in at least a one degree of freedom.

16. The station of claim 9, further comprising a motor coupled to said third stage and a computer coupled to said motor and said optical sensor.

17. The station of claim 9, wherein said coupling means is a multimode fiber.

18. The station of claim 9, wherein said coupling means is a multimode planar waveguide.

19. A method for aligning an input fiber array with a waveguide, comprising:
aligning a multimode fiber to a waveguide, the multimode fiber being coupled to an optical sensor; and,
sensing light emitted from the waveguide; and,
aligning an input fiber array with the waveguide.

20. The method of claim 19, further comprising aligning an output fiber array with the waveguide.

21. The method of claim 20, wherein the output fiber array is manually aligned with the waveguide.

22. The method of claim 20, wherein the output fiber array is automatically aligned with the waveguide.
